(19) United States
(12) Patent Application Publication
(10) Pub. No.: US 2008/0101666 A1
(43) Pub. Date: May 1, 2008

(54) AUTOMATED IMAGING SYSTEM WITH SLIDE MARKING

(75) Inventor: Barry Hunt, Andover, MA (US)

Correspondence Address: VISTA IP LAW GROUP LLP, 12930 Saratoga Avenue, Suite D-2, Saratoga, CA, 95070, US

(73) Assignee: CYTYC CORPORATION, Marlborough, MA (US)

(21) Appl. No.: 11/554,493

(22) Filed: Oct. 30, 2006

(51) Int. Cl. G06K 9/00

(52) U.S. Cl. 382/128

(57) ABSTRACT

An automated slide imaging system includes an imager for acquiring images of a specimen slide mounted on a slide stage movable relative to the imager; and an image processing system configured to process the acquired images and identify objects of interest on the slide. The image processing system is configured to identify one or more types of errors associated with each slide, which may relate to the respective specimen and/or to the preparation and/or imaging of the slide. The system comprises at least one marker in operative association with the image processing system for applying one or more human-readable marks to slides having one or more associated errors, or to slides having no errors, or both.

### FIELD OF THE INVENTION

The present invention is in the field of automated slide processing.

### BACKGROUND

At times, automated slide imaging systems encounter errors when imaging biological specimen slides. Such errors can relate to the biological specimen itself, such as a specimen having a low concentration of cells on the slide, or to the preparation of the slide, such as application of an incorrect or inadequate amount of stain. Such errors may also be mechanical in nature, such as, for example, a slide that was not loaded properly on the imaging table, or where the imaging system was not focused properly when acquiring images of the slide. Slides having imaging errors may be treated differently by the laboratory than slides having no imaging errors. For example, laboratory personnel may want to clean and re-image the slides having errors associated with them, or they may choose to forgo imaging of the slides and rely entirely on a manual review of the slides.

Several automated and semi-automated imaging systems are known in the art, such as, for example, those described in U.S. Pat. Nos. 6,665,060 and 7,006,674, which are incorporated herein by reference in their entirety. With certain automated imaging systems, such as the ThinPrep® Imaging System manufactured and distributed by Cytyc Corporation (www.cytyc.com), slide(s) having errors are identified on a list of slide identification codes provided to the screening laboratory. The laboratory personnel must check the list and manually locate the respective slides associated with the listed identification codes in order to identify those slides having errors and the nature of the particular error(s), which can be a time-consuming process.

### SUMMARY OF THE INVENTION

In one embodiment, an automated slide imaging system includes an imager for acquiring images of a specimen slide mounted on a slide stage movable relative to the imager; and an image processing system configured to process the acquired images and identify fields of view including objects of interest on the respective slides. The image processing system is configured to identify one or more types of errors that may be associated with each slide. Such errors may relate to the respective specimen, or to the preparation and/or imaging of the slide. The imaging system further comprises at least one slide marker in operative association with the image processing system for applying a human-readable mark to those slides having one or more associated errors. Additionally or alternatively, the same or a different marker may be used for applying a human-readable mark to those slides having no associated errors, thereby indicating that such slides were successfully processed by the imager.

Other and further embodiments and features of the invention will become apparent from the following detailed description.

### BRIEF DESCRIPTION OF THE DRAWINGS

FIG. 1 is a schematic view of a slide imaging system having a slide marker, according to one embodiment of the invention.

FIG. 2 is a top view of one embodiment of a specimen slide configured for use with the slide imaging system of FIG. 1.

FIG. 3 is a schematic view of one embodiment of a marker assembly located in proximity to a slide waiting area in the imaging system of FIG. 1.

FIG. 4 is a schematic view of another embodiment of a marker assembly, which is located within an imager of the imaging system of FIG. 1.

FIG. 5 is a schematic view of a slide imaging system having a light source that is part of a slide marking system according to an alternate embodiment of the invention

### DETAILED DESCRIPTION

Automated slide imaging systems are well-known in the art. These systems are generally designed to acquire and process images of specimen slides (e.g., biological specimen slides) in order to identify the location(s) of objects of interest on the respective slides, e.g., for facilitating subsequent human review of the slide by a cytotechnologist. The slides typically have a designated area adapted for the deposition of a specimen, which may be a cytological specimen, but may also be another type of specimen. By way of a well-known example, the cytological specimens may be prepared samples of cellular matter obtained from a cervical Pap smear. The Pap smear specimen slide is preferably a monolayer preparation, such as that provided by the Thin Prep slide preparation system manufactured and distributed by Cytyc Corporation, in which the cervical cells are disposed on the slide in a single layer to facilitate their imaging and analysis. Examples of apparatus used for preparing and depositing monolayer specimen samples on specimen slides are disclosed in U.S. Pat. No. 5,143,627, which is incorporated herein by reference in its entirety. Briefly, the specimen samples are stained and fixed to the slides for subsequent microscope review.

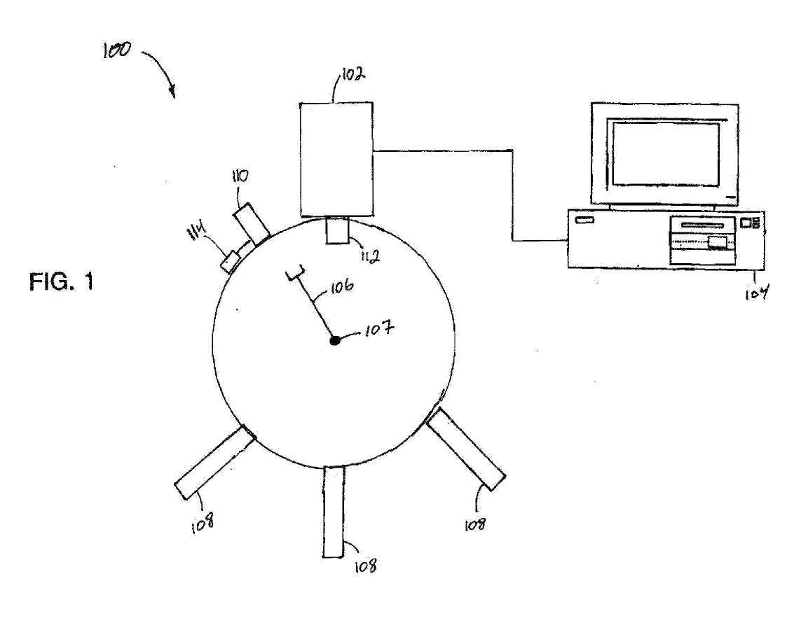

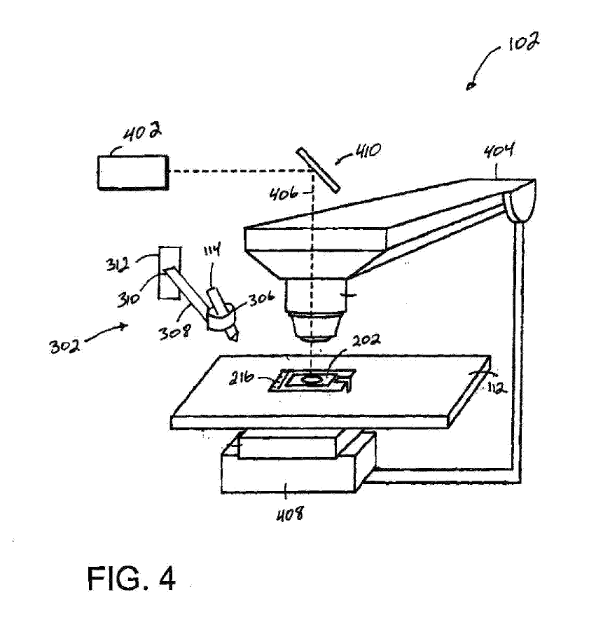

FIG. 1 is a schematic view of one embodiment of an automated slide imaging system 100, which is similar or identical in all aspects except those improvements disclosed herein to the automated slide imaging system disclosed in above-incorporated U.S. Pat. No. 7,006,674. The automated slide imaging system includes an optical system (or “imager”) 102 configured for acquiring images of a specimen slide mounted on a slide stage 112, which is movable relative to the imager 102. The imager 102 generally includes a high-speed electronic camera 402 and an automated microscope 404 (shown in FIG. 4). An image processing system is software-implemented in an associated controller computer system 104, and receives and processes acquired images from the imager 102 in order to distinguish cellular objects from artifacts, and identify objects of interest (and their location(s)) on the respective specimen slides. The image processing system is also configured to identify one or more types of errors that may be associated with each slide processed by the imager. Such errors generally relate to the respective specimen, slide preparation, or slide imaging process.

The slide stage 112 transports a specimen slide into and within the optical path of the microscope within the imager 102, in response to appropriate commands from the controller computer system 104. A robotic arm 106 (or “slide handler”), upon appropriate commands from the controller computer system 104, retrieves the respective specimen slides (i.e., one at a time) from respective storage locations in a slide-holding repository 108, and places the slides on the movable stage 112 for imaging. After a slide is imaged, the slide handler 106 returns the slide to its storage location in the repository 108. In some embodiments, the slide handler 106 pivots about an axis 107, and can reach the various components in the system, such as multiple repositories 108, the imager 102, and a slide waiting area 110 (described in greater detail below).

A slide-holding repository 108 can be (by way of non-limiting example) a box or a tray. In one embodiment of the imaging system 100, there are multiple repositories 108, each a cassette configured to hold multiple individual slides, each slide on an individual shelf in a respective cassette 108. There are preferably multiple slide-holding cassettes 108 associated with the automated imaging system 100.

In the illustrated embodiment, a slide “waiting area” 110 is provided, which is located adjacent to or otherwise in proximity to the slide stage 112. In particular, upon initiation of the slide imaging process for a new batch of slides, the slide handler 106 obtains a first slide from a cassette 108 and transports the slide to the movable stage 112. While the first slide is being processed by the imager 102, the slide handler 106 obtains a second slide from the same (or a different) cassette 108, and transports the second slide to the slide waiting area 110. Once imaging of the first slide is completed, the slide handler 106 removes the first slide from the movable stage 112, transports it to the waiting area 110, obtains the second slide from the waiting area 110, and transports the second slide to the movable stage 112. The slide handler then transports the first slide from the waiting area 110 back to the cassette 108, obtains a third slide from the same (or a different) cassette 108, and transports the third slide to the waiting area 110. This process is continued until all of the slides have been imaged.

The slide handler 106 positions the respective slides in a precise location and orientation on the movable stage 112. Images obtained by the imager 102 are sent to the image processing system, which may be incorporated within the controller computer system 104, or may be provided in a separate computer system. The image processing system processes acquired images of the specimen slides in order to identify objects of interest therein, including but not necessarily limited to a listing of recommended locations (or “fields of view”) on the respective specimen slides for subsequent laboratory review, e.g., by a cytotechnologist or a pathologist.

Of particular relevance to the present invention, the image processing system determines whether the image data obtained from a specimen slide conforms to a predetermined set of criteria relating to the particular specimen, its preparation, and/or the imaging process. For example, the image processing system may calculate the density of cellular objects on the respective slides to determine whether the cell density is sufficient for an accurate biological assessment of the specimen sample. Another example of a specimen-related criteria is a relative presence of blood cells in the specimen sample. The image processing system may also determine whether the specimen sample on the slide was stained properly, if there were air bubbles trapped within the sample, if the slide was properly positioned on the movable stage, if the background illumination is sufficiently uniform, or if the camera was adequately focused, as well as a number of other possible errors that may occur during slide preparation and imaging.

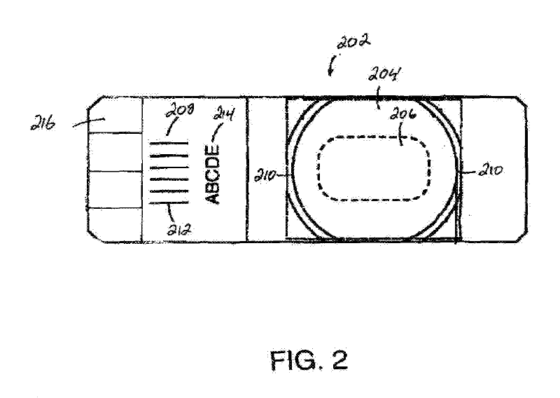

FIG. 2 is a top view of one embodiment of a microscope slide 202, which can be used with embodiments of the imaging system 100 disclosed herein. The slide 202 has a specimen area 204 adapted for the deposition of a sample, such as a cytological specimen 206, thereon. Typically, the slide 202 has toleranced dimensions and chamfered edges to facilitate its handling and use by automated (and calibrated) equipment, such as the automated imaging system 100. The slide 202 is preferably manufactured from glass, and has a width of about one inch, a length of about three inches, and a thickness of about 0.04 inches.

One end 208 of the slide 202 may be frosted or coated (or have a label applied thereto) to facilitate marking and identification of the specimen 206 thereon in human readable form. The frosted end 208 may have an area of about one square inch. A frosted annulus 210, defining an area to where the cells are transferred, may also be provided to facilitate scanning of sparse specimens. The slide 202 may be marked with a barcode 212, as well as indicia 214 containing information necessary for matching the results of an analysis with the correct patient, for example identification of the patient from whom the specimen on the slide was obtained and/or a name of a doctor or medical practice that provided the specimen on the slide.

In accordance with some embodiments of the invention, if the image processing system 100 identifies or otherwise determines that there are one or more errors associated with one or more of the specimen quality, preparation and/or imaging of a respective specimen slide, one or more corresponding, human-readable marks are automatically made on the slide by a slide marker 114 (FIG. 4) associated with and/or incorporated into the automated imaging system 100. In this manner, a cytotechnologist or other laboratory personnel can subsequently easily and quickly identify whether there was an error associated with a given slide, without having to cross-reference a list of slide identification codes. Thus, in one aspect, disclosed herein is an automated slide imaging system, comprising at least one slide marker for marking a slide having one or more error(s) associated with one or more of the slide's content, preparation, and imaging.

In some embodiments, the end 208 of the slide 202 comprises a marking area 216 where a marker 114 associated with and/or incorporated into the automated imaging system 100 places a mark in accordance with the methods disclosed herein. While the marking area 216 can be anywhere along the slide end 208, it is preferably located at a position that can easily be seen by laboratory personnel when the slide 202 is located in a repository, such as a slide cassette 208. Therefore, in some embodiments, such as the one shown in FIG. 2, the marking area 216 is at a terminal edge of the slide end 208.

It will be appreciated that marks made to a slide will preferably vary depending on what information is being conveyed to a subsequent reviewer. For example, different marks may be used to indicate respective different types of errors relating to the specimen, slide preparation (e.g., staining) of the slide, and slide imaging (e.g., mounting or focus). It will also be appreciated that, while in some embodiments the slides are marked when there are one or more errors associated with the slide, in alternate embodiments it may be preferred to mark a slide only when there are no associated errors. In such alternate embodiments, the presence of a mark indicates that the specimen meets minimum criteria in terms of one or more of specimen quality, slide preparation process and slide imaging process, i.e., that the specimen was properly prepared and affixed to the slide, and was successfully imaged. In still other embodiments, the marker 114 marks a slide 202 both when there is an error and when there is no error associated with the slide. In such further embodiments, the color and/or location and/or shape and/or other characteristic of the slide markings are different when there is an error than when there is no error. For example, in some embodiments, the automated imaging system 100 is provided with a plurality of markers for creating different characteristics in respective slide marks.

The marking area 216 on the slides can be a single area or it can be divided into multiple (e.g., smaller) sections. For example, FIG. 2 shows an embodiment of a slide 202 in which the marking area 216 is divided into four separate sections. For instance, the marker 114 can mark one section when the imaging has been successful, a second section when there is an error relating to the specimen, a third section when there is an error relating to slide preparation, and a fourth section when there is an error relating to slide imaging. In the embodiments where the marking area 216 is a single area, any mark made by the marker 114 is within that single area, and a difference in a shape or color of the mark can be used to convey information to the laboratory personnel about the slide.

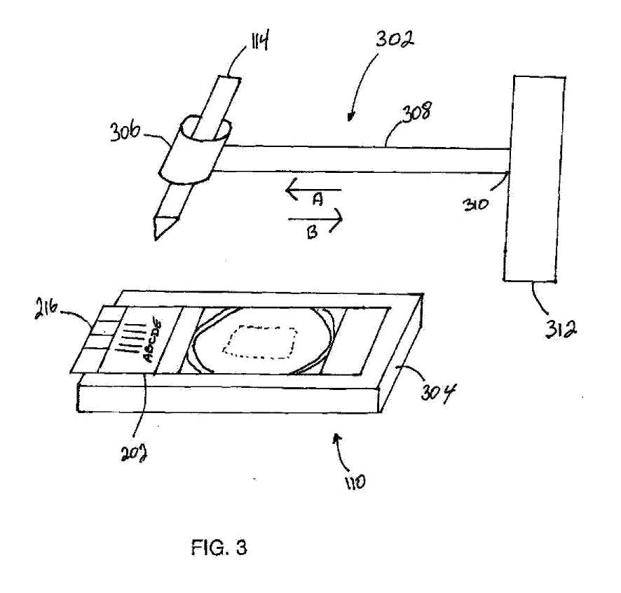

Preferably, the marker 114 is held within a marker assembly. FIG. 3 is a simplified illustration of one embodiment of a marker assembly 302, which is located in proximity to the waiting area 110 of the slide imaging system 100. For example, the waiting area 110 can comprise multiple tiers, each configured to hold a slide. Only the top surface 304 of the waiting area 110 is shown in FIG. 3. In the illustrated embodiment, a slide 202 is placed on the top surface 304 of the waiting area 110. The marker assembly 302 comprises a marker 114. The marker 114 places physical marks at the marking area 216 of the slide 202. The marker 114 is preferably capable of marking on conventional glass slides, float glass slides, coatings and labels applied on or to the glass slide, as well as glass or plastic cover slips.

In one embodiment, the marker 114 is a Sharpie® pen, which can be obtained from the Sanford Corporation in Bellwood, Ill., to generate the mark on the specimen. This pen is widely used and accepted for manually marking cover slips and slides. Solvent based ink is preferred because it marks reliably and quickly on glass or plastic cover slips, dries quickly so it does not smudge easily, is fairly translucent, and is non-toxic.

The marker motion is provided by a cantilevered arm 308 rotating about a fixed pivot point 310, or extending or contracting in the direction of arrows A and B, respectively. This arrangement provides highly repeatable, reliable motion with minimal frictional effects. A motor 312 is used to drive the marker 114; however, other numbers and types of actuators are possible. The marker assembly 302 preferably includes a capping/uncapping mechanism (not shown), designed to prevent the drying of the tip of the marker 114. The marker 114 is held firmly within a marker holder 306 during operation, without slippage or backlash due to variation in marker manufacturing. The marker 114 is easy to load and unload as it can be manually loaded and clamped in the holder 306. The marker holder 306 can include a clamping mechanism to securely hold the marker 114 and is structurally robust enough to prevent damage due to accidental bumps.

FIG. 4 illustrates another embodiment, where the marker assembly 302 is located within the imager 102. In this embodiment, the slide 202 is placed on the slide stage 112. The function of the individual components of the marker assembly 302 when it is located within the imager 102 is analogous to the function of the components as described above with respect to the placement of the marker assembly 302 in proximity to the waiting area 110. The marker assembly 302 is located such that it stays clear of a path of light 406 originating from an illumination light source 408, which light 406 travels through the slide 202, through the automated microscope 404 and mirror 410, respectively, and to a high-speed electronic camera 402.

In alternative embodiments, the above-incorporated U.S. Pat. No. 7,006,674 (“the '674 patent”) further discloses a marker (68 in FIG. 3, and column 5, lines 34-43) that may be employed for use as a marker in the automated imaging system 100 of the present invention. As described in the '674 patent, upon a command from the controller computer system, a marker 68 automatically place a “dot” or other visible indicia in the areas of interest within the specimen where potentially abnormal cells may be located. In some embodiments of the present invention, a marker similar or identical to the marker 68 of the '674 patent is configured to places a mark in the appropriate section of the respective slide marking area 216 upon a command from the controller computer system 104. Alternatively, U.S. Patent Application Publication 2006-0077538 A1, incorporated by reference herein in its entirety, further discloses a marker (FIGS. 8 and 9, and Paragraphs [0143]-[0150]) that may be employed for use as a marker in the automated imaging system 100 of the present invention.

In other embodiments, the automated imaging system 100 may comprise a second marker distinct from the first marker, which is also in communication with the controller computer system 104, and is configured to place a mark in the appropriate section of the marking area 216 upon a command from the controller computer system. In these embodiments, the marker(s) of the imaging system 100 are located in close proximity to the movable slide stage 112. Thus, when the image processing system determines that a mark should be made on the slide (e.g., when there is an error—or no error—associated with slide imaging), a selected the marker marks the respective slide while the slide is still positioned on the movable stage 112.

As discussed above, in some embodiments, the slide handler 106 transports slides to and from the waiting area 110. In such embodiments, and as shown in FIG. 1, a marker 114 may be located in close proximity to the waiting area 110 so that, once a slide has been processed and is transported to the waiting area 110, but prior to its transportation back to its respective storage cassette 108, the marker 114 marks the slide according to the instructions received from the image processing system.

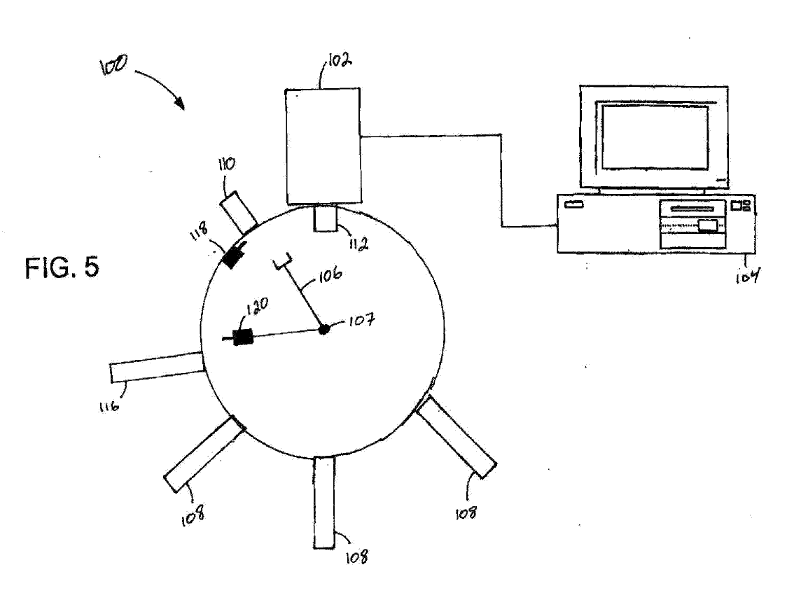

In some embodiments, such as the one shown in FIG. 5, there is a separate repository 116 used for slides having one or more errors associated therewith. In particular, the slide handler 106 transports slides having identified errors into the “error slide” repository 116, subsequent to their imaging. For example, the error slide repository 116 may be a cassette specifically set aside for the slides having an error associated with their imaging, or a box or a tray onto which the error slides are placed.

In an alternate embodiment, the marking area 216 of each slide 202 is marked with one or more types of “invisible” ink prior to when the respective slide is imaged, which ink type(s) become visible to the human eye when exposed to light having certain wavelength(s). By way of example, the marking area 216 may be marked with only one type of invisible ink, or in embodiments where the slide marking area 216 comprises multiple sections, each section of the marking area 216) may be marked with a different type of invisible ink. In some embodiments, the ink in each section of the marking area 216 becomes visible to the human eye when exposed to light of certain wavelength, but does not become visible when exposed to light of wavelength that would render the ink of another section of the marking area 216 visible. Thus, there is a one-to-one relationship between the type of ink and the wavelength that renders it visible. The invisible ink may be applied during the manufacturing of the slide, or a marker, such as marker 114 (FIG. 1) may apply the invisible ink to the appropriate section(s) of the slide marking area 216.

As shown in FIG. 5, light source 118 capable of emitting light at various different wavelengths is provided to selectively activate (i.e., to thereby make visible to the human eye) the respective ink sections, as instructed by the image processing system. The light source 118 may be located in close proximity to the waiting area 110. After a slide has been imaged, the slide handler 106 removes the slide from the 112 and transports it to the waiting area 110. The image processing system in the meantime determines whether the imaging of the slide was successful or whether there was an error associated with its imaging (or its specimen content and/or preparation), and if so, determines the nature of the error. The controller computer system 104 then sends a command to the light source 118, which illuminates the marking area 216 of the imaged slide in the waiting area 110 with the appropriate wavelength of light to render the ink in the pertinent section(s) of the marking area 216 visible to the human eye. The slide handler 106 then returns the slide to the appropriate repository 108.

In alternate embodiments, a marker applies the invisible ink to the appropriate section(s) of the slide marking area 216 following its imaging, and the slide handler 106 returns the slides to the repository 108 prior to illumination of the marking area 216 by a light source. After all of the slides in a particular repository 108 have been imaged and returned to the respective repository 108, a light source 120 illuminates all of the slides in the repository 108 at one time. By way of example, the slides may be marked with the same type of “invisible” ink, but in different sections of the respective slide marking areas 216, depending on the information to be conveyed about the slide (i.e., whether there any detected errors associated with the specimen, preparation and/or imaging of the slide, and if so, what type of errors) and the same wavelength light renders the respective ink markings visible. By way of another example, the light source 120 may shine light of different wavelengths in succession on the slides housed in a cassette (post-imaging), thereby rendering visible different types of ink markings on the respective slides.

Examples of invisible ink include irreversible photochromic ink such as those described in U.S. Pat. Nos. 4,812,171, 5,581,090, 5,436,115, and U.S. Patent Application Publication 2006-0053975 A1, which are all incorporated by reference herein in their entirety. The irreversible ink preferably undergoes a color change upon exposure to light, such as ultraviolet light or infrared light.

As will be appreciated, many arrangements and configurations may be implemented in embodiments of an automated image processing system according to the present invention, in order to mark the individual slides with one or more types of ink, which ink may be visible to begin with, or may be selectively made visible by application of a respective light wavelength, thereby conveying useful information about the slides to downstream laboratory personnel.

In some embodiments, the automated imaging system verifies whether the imaging of an entire batch of slides was successful or not. By way of example, prior to imaging a batch of slides, a first calibration slide is imaged. If the imaging of the calibration slide is successful, then the automated imaging system proceeds with the imaging of each slide of the batch. Subsequent to the imaging of the last slide of the batch, a second calibration slide is imaged. If the imaging of the second calibration slide is also successful, the image processing system accepts and processes the data obtained from the imaging of that slide batch. However, if the imaging of the second calibration slide is not successful, then the automated imaging system ignores the imaging data obtained from the entire batch of slides.

In such embodiments, when the imager concludes the imaging of a particular slide, the data for that slide is sent to the image processing system and temporarily stored. Only after the second calibration slide is successfully imaged does the image processing system accept and process the data for the particular batch of slides, during which time the image processing system identifies which slides in the batch have errors associated with their specimen, preparation and/or imaging. In such embodiments, the slides in a particular batch are preferably not marked until acceptable data from the batch, i.e. a successful first and second calibration imaging, is obtained. After a batch is successfully imaged, the imager begins the imaging of the slides in the next batch. While the imager is imaging the slides in the next batch, the slide handler 106 transfers the slides in the just-completed batch to the waiting area 110 (e.g., one at a time), where they can be marked according to the respective instructions from the controller computer system 104 for the particular slide. Marking the slides of a just-completed batch while the imager is imaging the next batch saves time and speeds up the overall imaging process, as the wait time, during which a slide is being imaged, is utilized for marking the slides. No additional time during the imaging is taken for marking.

In embodiments where an invisible ink is used to mark the slides, after the successful second calibration imaging, and while the imager is imaging the slides in the next batch, the light source 120 illuminates the respective slides in the repository 108. In embodiments where the slides are marked with a different ink requiring a different wavelength of light to render the marks visible, the light source 120 illuminates each slide in the just-completed batch with the appropriate wavelength of light.

In the embodiments where a separate repository 116 is used for temporarily storing slides having one or more associated errors, the light source 120 may be used to illuminate the entire contents (i.e., containing just the “no error” slides) of the slide repository cassette 108 of a just-completed batch, thereby marking only the successfully imaged slides. Thereafter, the slide handler 106 returns the slides from the temporary repository 116 to the cassette 108 of the just-completed batch. In this manner, only the slides in the just-completed repository that do not have a visible mark are those that have associated errors. In the alternate embodiments where both the successful slides and the error slides are given visible marks, the light source 120 illuminates the repository 116 prior to the transfer of slides back to the repository 108.

The invention may be embodied in other specific forms besides and beyond those described herein. For example, there are many ways other than those described herein for the automated imaging system to mark a slide in a human-readable form. The foregoing embodiments are therefore to be considered in all respects illustrative rather than limiting, and the scope of the invention is defined and limited only by the appended claims and their equivalents, rather than by the foregoing description.

1. A slide imaging system, comprising:
an imager comprising a slide stage and an optical system configured to acquire images of specimen slides;
an image processing system configured to process the acquired slide images and determine whether an error is associated with a respective slide, its imaging, or both; and
a marker in operative association with the image processing system and configured to selectively mark respective specimen slides in accordance with instructions received from the image processing system, the instructions pertaining to the existence or lack thereof of at least one error associated with the respective specimen slides.

2. The system of claim 1, wherein the marker is configured to mark those specimen slides having at least one error associated therewith.

3. The system of claim 1, wherein the marker is configured to mark those specimen slides having no error associated therewith.

4. The system of claim 1, wherein the marker marks the slides with an ink that is immediately visible to humans.

5. The system of claim 1, wherein the marker marks the slides with an ink that is substantially invisible to humans unless the ink is activated by a light source.

6. The system of claim 5, further comprising a light source configured to selectively illuminate the slides, thereby rendering the ink visible to humans.

7. A slide imaging system, comprising:
an imager comprising a slide stage and an optical system configured to acquire images of specimen slides, wherein each specimen slide is preprinted with an ink that is substantially invisible to humans unless the ink is activated with a light source;
an image processing system configured to process the acquired slide images and determine whether an error is associated with a respective slide, its imaging, or both;
and
a light source in operative association with the image processing system, the light source configured to selectively illuminate specimen slides in accordance with instructions received from the image processing system pertaining to the existence or lack thereof of at least one error associated with the respective specimen slides.

8. The system of claim 7, wherein the light source is configured to illuminate those specimen slides having at least one error associated therewith.

9. The system of claim 7, wherein the light source is configured to illuminate those specimen slides having no error associated therewith.

10. The system of claim 7, wherein the light source illuminates the slides with ultraviolet light.

11. A method of identifying a slide having an error associated with its imaging, comprising:
automatically scanning a plurality of biological specimen slides using an automated imaging system;
identifying at least one slide having no error associated with its imaging; and
automatically marking the at least one slide having no error associated with its imaging.

12. The method of claim 11, further comprising identifying at least one slide having an error associated with its imaging.

13. The method of claim 12, further comprising marking the at least one slide having an error associated with its imaging, wherein the slide having an error associated with its imaging is marked differently than the slide having no error associated with its imaging.

14. The method of claim 13, wherein the difference in the marks is selected from the group comprising different color marks, different shape marks, and marks in different locations.

15. The method of claim 11, wherein the slides are marked with an ink that is immediately visible to humans.

16. The method of claim 11, wherein the slides are marked with an ink that is substantially invisible to humans unless the ink is activated by an appropriate wave-length light source.

17. The method of claim 16, further comprising selectively illuminating the marked slides with a narrow-band wavelength light source, thereby rendering the ink visible to humans.

18. A method of identifying a slide having an error associated with its imaging, comprising:
automatically scanning a plurality of biological specimen slides using an automated imaging system, wherein each specimen slide is preprinted with an ink that is substantially invisible to humans unless the ink is activated with a light source;
identifying at least one slide having no error associated with its imaging; and
automatically illuminating the at least one slide having no error associated with a light source to render the preprinted ink visible.

19. The system of claim 18, wherein the light source illuminates the slides with ultraviolet light.
